(19) United States
(12) Patent Application Publication
(10) Pub. No.: US 2001/0029526 A1
(43) Pub. Date: Oct. 11, 2001

(54) Method for controlling a mobile agent

(76) Inventors: Taiko Yokoyama, Sagamihara (JP); Motoaki Satoyama, Sagamihara (JP); Yoshiaki Morimoto, Tokyo (JP); Jun Maeoka, Kawasaki (JP); Nobuhisa Kobayashi, Hitachiknaka (JP); Nobuyoshi Ando, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/785,478

(22) Filed: Feb. 20, 2001

(30) Foreign Application Priority Data
Mar. 31, 2000 (JP) 2000-101214

(51) Int. Cl. G06F 15/16

(52) U.S. Cl. 709/218; 709/200; 709/204

(57) ABSTRACT

In servers that distribute mobile agents, controlling the traveling time of distributed agents is difficult. Also, maintenance management is difficult when there are large numbers of frequently updated mobile agent traveling destinations.

In the present invention, traveling lists are managed separately from agent programs and traveling time is predicted based on home terminal information at traveling destinations and information about programs to be executed at traveling destinations. The traveling destinations are divided into multiple groups as needed and agent distribution is performed through these groups. This allows the time involved in traveling to be controlled. Also, the server performs maintenance and management of traveling destinations, thus allowing large numbers of traveling destinations and frequent updates.

### BACKGROUND OF THE INVENTION

The present invention relates to a method for distributing and executing mobile agents that execute service programs while moving between a plurality of home terminals connected to a network.

Mobile agent technology provides a technology where a program can be executed while moving between a plurality of computers. In conventional mobile agents, the agent creator includes traveling paths or traveling paths in the program. Japanese laid-open patent publication number Hei 11-149426 presents a technology for fault avoidance when a fault occurs at an agent destination.

In conventional mobile agents, the method for determining a destination is contained in the agent program. This created the following problems.

(1) The time involved in completing a traveling operation is difficult to control. Also, predicting the time involved in completing a traveling operation is difficult to predict since the performance of destination terminals is not uniform.

(2) Since the traveling destinations are not completely identical, putting a plurality of service programs in a single traveling agent is difficult. This makes it necessary to distribute agents for each service programs, increasing communication costs.

(3) Maintaining and managing traveling destinations is difficult when there is a large number of traveling destinations or when traveling destinations are frequently updated.

### SUMMARY OF THE INVENTION

The object of the present invention is to provide a method for controlling a mobile agent that allows the traveling time of a mobile agent to be controlled.

The method for controlling a mobile agent according to the present invention implements the following procedure.

The traveling list and the agent program are managed separately. A server apparatus is equipped with a method for distributing mobile agents where a traveling list is added to the agent program when an agent is distributed. Each home terminal is equipped with a method for executing mobile agents where the added traveling list is read to determine the next destination. This allows traveling lists to be joined and split before distribution, and the time involved in traveling operations can be controlled by distributing a plurality of agents containing the same agent program.

Also, by separating the agent program from the traveling list and adding a single traveling list to a plurality of agent programs, communication costs can be reduced.

Also, by equipping the server apparatus with means for maintaining and managing traveling lists, the maintenance and managing of traveling lists is made easier when there is a large number of traveling destinations or when the traveling destinations are frequently updated.

### BRIEF DESCRIPTION OF THE DRAWINGS

FIG. 1 shows an overall system architecture and hardware architecture for the present invention.

FIG. 2 shows the operations performed in the overall system of the present invention.

FIG. 3 shows a sample software configuration and data flow in a server according to the present invention.

FIG. 4 shows a sample software configuration and data flow in a home terminal according to the present invention.

FIG. 5 shows sample contract data elements and a data format used by a mobile agent distribution program in a server.

FIG. 6 shows sample service program data elements and a data format used by a mobile agent distribution program in a server.

FIG. 7 shows sample fault data elements and a data format used by a mobile agent distribution program in a server.

FIG. 8 shows sample service schedule management data elements and a data format used by a mobile agent distribution program in a server.

FIG. 9 shows sample mobile agent elements and data format used in mobile agents generated and distributed by a mobile agent distribution program in a server.

FIG. 10 shows sample fault message elements and data format used in fault messages sent from a home terminal to a server when a fault takes place.

FIG. 11 shows sample mobile agent execution state management data elements and a data format used by a mobile agent distribution program in a server.

FIG. 12 shows a flow of operations performed when a fault takes place while a mobile agent is traveling.

FIG. 13 is a flowchart of an event processing routine in a server.

FIG. 14 is a flowchart of agent distribution operations activated by the program shown in FIG. 13.

FIG. 15 is a flowchart of distribution area dividing operations activated by the program shown in FIG. 14.

FIG. 16 is a flowchart of traveling time prediction operations activated by the program shown in FIG. 15.

FIG. 17 is a flowchart of mobile agent termination operations activated by the program shown in FIG. 13.

FIG. 18 is a flowchart of message arrival operations activated by the program shown in FIG. 13.

FIG. 19 is a flowchart of a service schedule management routine activated in a server independently from an event processing routine.

FIG. 20 is a flowchart of an event processing routine containing mobile agent execution operations in a home terminal.

FIG. 21 is a sample display screen showing the execution status of a mobile agent displayed on a display device of a server when a specific fault takes place when a mobile agent is traveling or when a server administrator makes a request.

FIG. 22 shows an example of a configuration of a system implemented using communication method where connections are made by way of base stations.

FIG. 23 shows sample contract data elements and a data format used by a mobile agent distribution program in a server.

FIG. 24 shows a sample table generated based on the contract data from FIG. 23 where terminals that can be connected in transceiver mode are grouped together.

FIG. 25 shows sample traveling list groups for mobile agents in a system according to the present invention.

FIG. 26 shows a sample software architecture and data flow in a home terminal according to the present invention.

FIG. 27 is a flowchart of distribution area dividing operations activated by the program shown in FIG. 14.

FIG. 28 is a flowchart of a event processing routine containing mobile agent execution operations in a home terminal.

FIG. 29 is a flowchart of base station fault avoidance operations activated by the program shown in FIG. 28.

### DESCRIPTION OF THE PREFERRED EMBODIMENT

The following is a description of an embodiment of the present invention, with references to the figures.

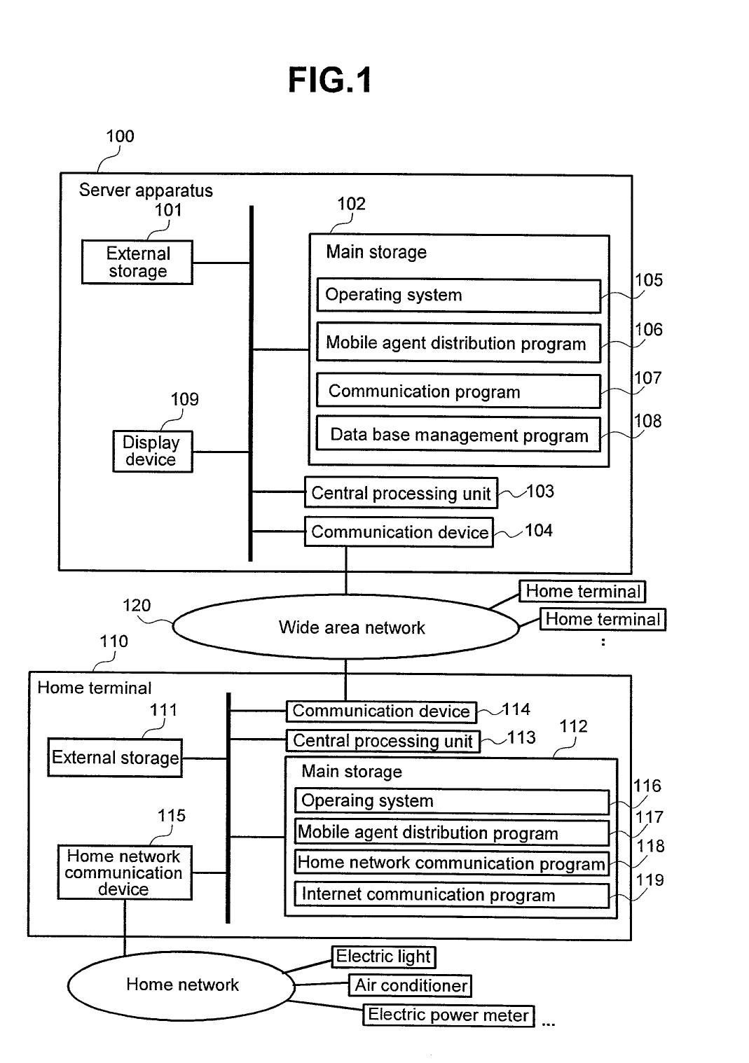

FIG. 1 shows the overall architecture of one implementation of the present invention.

A server apparatus 100 includes: an external storage 101; a main storage 102; a central processing unit 103; a communication device 104; and a display device 109. The main storage 102 contains: an operating system 105; a mobile agent distribution program 106; a database management program 108; and the like.

A home terminal 110 is connected to the server apparatus 100 by way of a wide area network 120 and includes: a secondary storage 111; a main storage 112; a central processing unit 113; a communication device 114; and a home network communication device 115. The home network communication device 115 is connected to a home network that connects electrical appliances such as electric lights and air conditioners. The main storage 112 contains: an operating system 116; a mobile agent execution program 117; a home network communication program 118; and an internet communication program 119. The server apparatus 100 is connected, along with the home terminal 110, is connected to the wide area network 120. Multiple home terminals having the same structure as that of the home terminal 110 are connected to the wide area network 120.

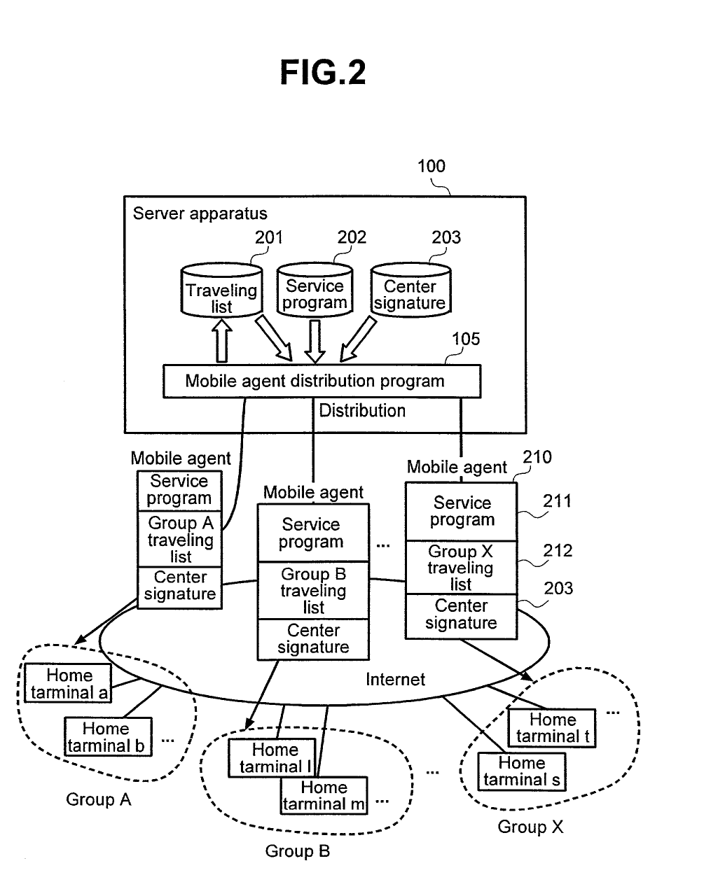

FIG. 2 shows hoe the server 100 performs mobile agent distribution. The server 100 distributes mobile agents 210 to the home terminals connected to the wide area network 120 to provide services. This is done by forming multiple groups of distribution destinations so that predetermined conditions are met, and then a mobile agent is sent to each of these groups. The sending of the mobile agents 210 is performed by the mobile agent distribution program 106. When the mobile agents are to be distributed, the distribution destinations are divided into groups as needed and a traveling list 201 is generated for each group. The mobile agent 210 is generated using this traveling list 201, service program data 202, and a center signature 203. The mobile agent 210 is formed from a necessary service program 211, a traveling list 212 for the group, and the center signature 203. Multiple service programs 211 can be contained in a single mobile agent, but there is no need to execute all the service programs at each of the home terminals traveled. The traveling list 212 contains information about the service programs to be run at each home terminal. When traveling, the mobile agent 210 executes service programs, collects data such as account information at each home terminal, and returns to the server 100 when its traveling is completed.

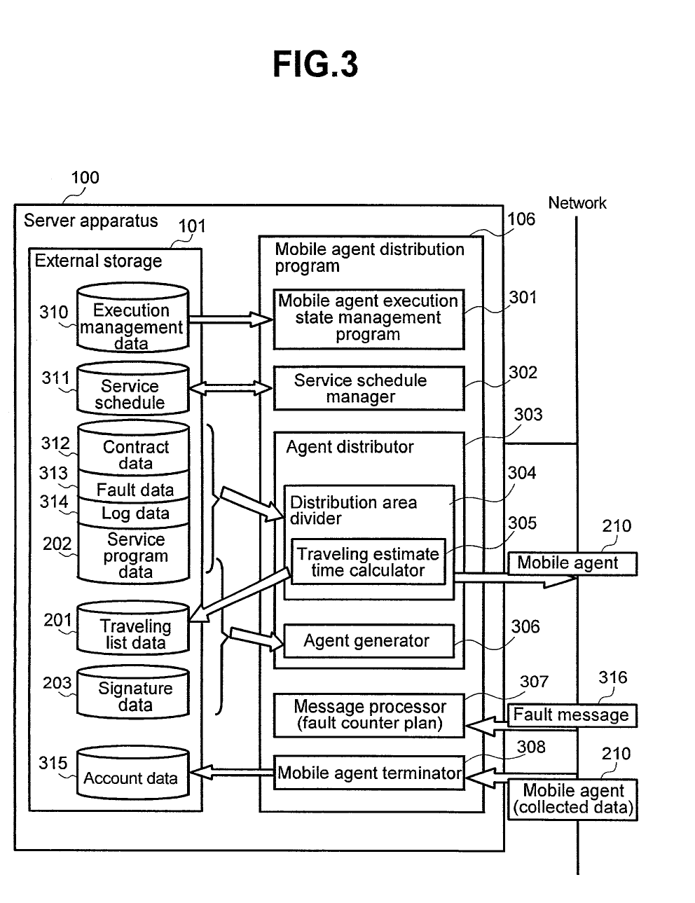

FIG. 3 shows the detailed features of the mobile agent distribution program 106 in the server 100. Execution management data 310, a service schedule 311, contract data 312, service program data 202, and signature data 203 are stored beforehand in the external storage 101 of the server 100. The mobile agent distribution program 106 is formed from: a mobile agent execution state management program 301; a service schedule management program 302; an agent distributor 303; a message processor 307; and a collected data processor 308. The agent distributor 303 is formed from a distribution area divider 304 containing a traveling estimate time calculator 305 and an agent generator 306.

These features will be described below.

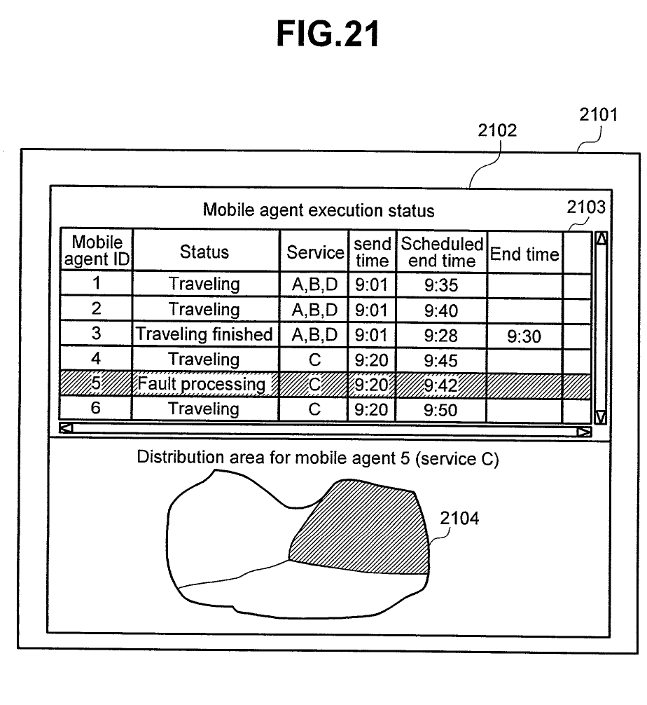

The mobile agent execution state management program 301 monitors the traveling status of a mobile agent by referring to the execution management data 310, which contains the execution state of a mobile agent. In cases such as when the mobile agent has not returned significantly after a traveling limit time has passed, the server administrator is notified by displaying information to the display device 109, generating sound/voice, or the like. Also, an execution state 2102 can be displayed to the display device 109, e.g., as shown in FIG. 21, in response to a request from the administrator. When a mobile agent from a mobile agent list 2103 is selected using a pointing device such as a mouse on a display screen 2101, the corresponding traveling area is indicated on a distribution area map 2104.

The service schedule manager 302 refers to the service schedule 311, which contains the distribution schedule for services, and issues request events so that, for example, agents containing the particular service program are distributed at service distribution times.

The agent distributor 303 is activated by the service schedule manager 302. First, the distribution area divider 304 uses contract data 312, fault data 313, log data 313, and the service program data 202 to generate the traveling list data 201. Next, the agent generator 306 generates and sends a mobile agent using the service program data 202, the traveling list data 201, and the center signature data 203.

The message processor 307 performs fault processing for a message 316 sent by the traveling mobile agent 210. The fault information is stored in the fault data 313. The fault data 313 is used when subsequently generating traveling lists.

The mobile agent terminator 308 tabulates the data collected by the mobile agent 210 and stores the results in account data 315 and the log data 314. The account data 315 is used to calculate usage fees for services, and the log data 314 is used when generating subsequent traveling lists.

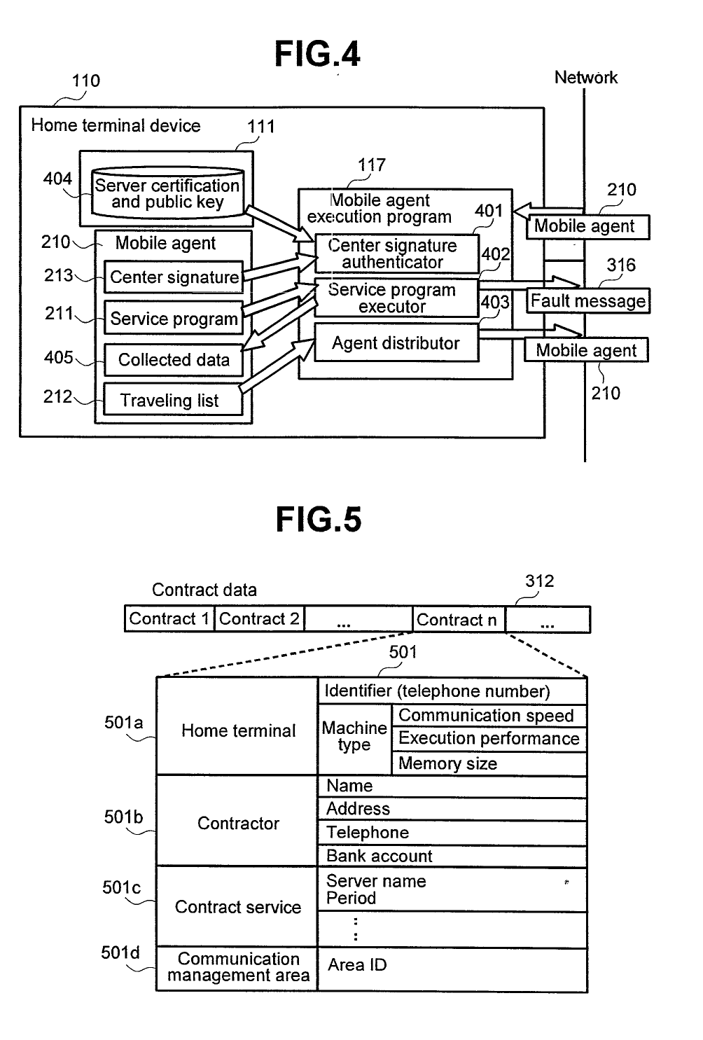

FIG. 4 shows operation sequences performed by the mobile agent 210 in the home terminal 110. A center server certification and public key 404 are stored beforehand in the external storage 111 of the home terminal. The mobile agent execution program 117 is formed from a center signature authenticator 401, a service program executor 402, and an agent distributor 403. When the mobile agent is still at the preceding home terminal, the center signature authenticator 401 authenticates the legitimacy of the mobile agent 210 using the server certification and public key 404 stored beforehand in the home terminal. After authentication, the mobile agent 210 is permitted to move to the home terminal. The service program executor 402 uses the execution service program data contained in the traveling list 212 to select and run the programs to be executed from the service program 211. The data obtained from this execution is stored in the collected data 405 of the mobile agent. The agent distributor 403 refers to the traveling list and obtains the next home terminal that the mobile agent has to visit. Authentication of the center signature is requested from that home terminal. If authentication is successful, the mobile agent 210 is sent to the next home terminal. If a connection cannot be made to the next home terminal, authentication fails at the next home terminal, the next home terminal rejects the mobile agent, or the like, a fault message 316 is generated and sent to the server 100. Then, the current home terminal waits for the server to send back a fault avoidance traveling list.

FIG. 5 shows sample contents of the contract data 312. The contract data 312 is a collection of multiple contract information 501. For each home terminal, there is one contract information 501 containing home terminal information 501a, contractor information 501b, contract service information 501c, and communication management area 501d. The home terminal information 501a includes an identifier for the home terminal (e.g., a telephone number used by the home terminal for communication) and information about the machine type of the terminal. The machine type information contains communication speed, execution performance, and memory size. The contractor information 501b contains a contractor name, address, telephone number, and bank account number for transactions. The contract service information is a list containing an entry for each contracted service. Each entry is a combination of the name of the contracted service and the period during which the service is to be received. The communication management area 501d is an area ID for the area in which communication fees for communications (telephone calls) are identical.

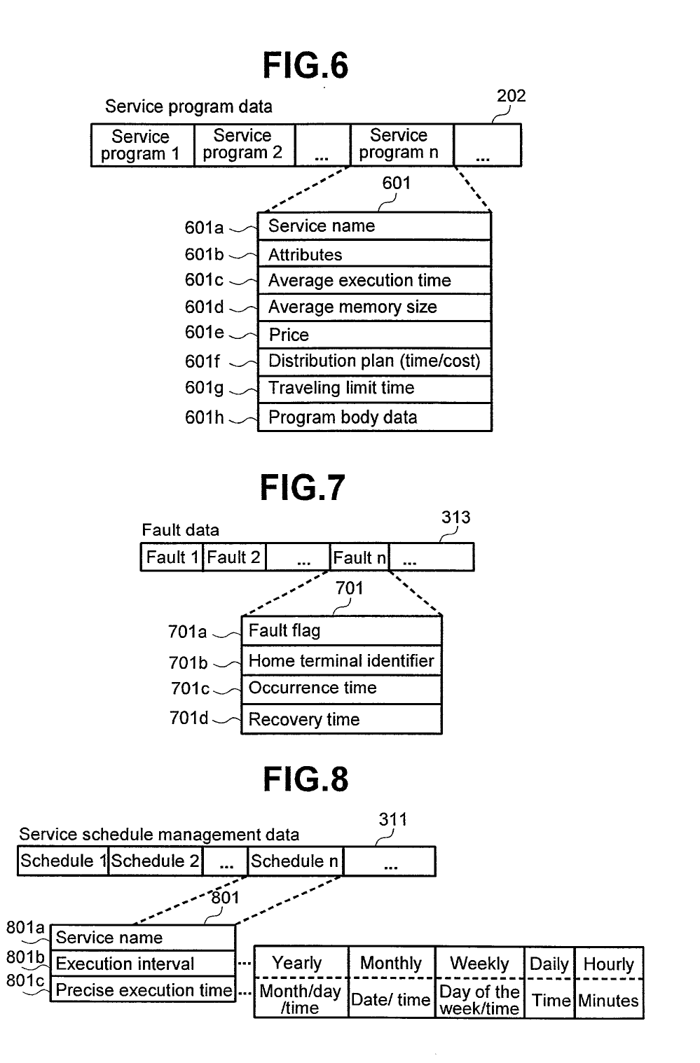

FIG. 6 shows sample contents of the service program data 202. The service program data 202 is formed from a set of service program-specific information 601, where there is one service program-specific information 601 for each type of provided service. The service program-specific information 601 is formed from a service name 601a, attributes (e.g., service provider name) 601b, an average execution time 601c, an average memory usage 601d, a service price 601e, a distribution plan 601f, a traveling limit time 601g, and a program body data 601h. The distribution plan 601f is used to determine if distribution times are to be strictly followed or if a certain amount of leeway should be given while keeping costs (e.g., communication fees) down. This can be selected according to the nature of the provided service.

FIG. 7 shows sample contents of the fault data 313. The fault data 313 is a collection of fault information 701 for faults that have been reported in the past. The fault information 701 is formed from a fault flag 70 la indicates whether the fault is current or not, a home terminal identifier 70 lb of the home terminal at which the fault occurred, an occurrence time 701c when the fault occurred, and a recovery time 701d when the fault was recovered.

FIG. 8 shows sample contents of the service schedule management data 311. The service schedule management data 311 is a collection of schedule information 801, with one schedule information 801 for each service. The service schedule information 801 is formed from a service name 801a, an execution interval 801b, and a precise execution time 801c. The execution interval 801b indicates the period after a service has been executed before it is executed again, e.g., once a month, once a week. If, for example, a service is weekly, the precise execution time 801c indicates at what time and on what day of the week distribution is to begin.

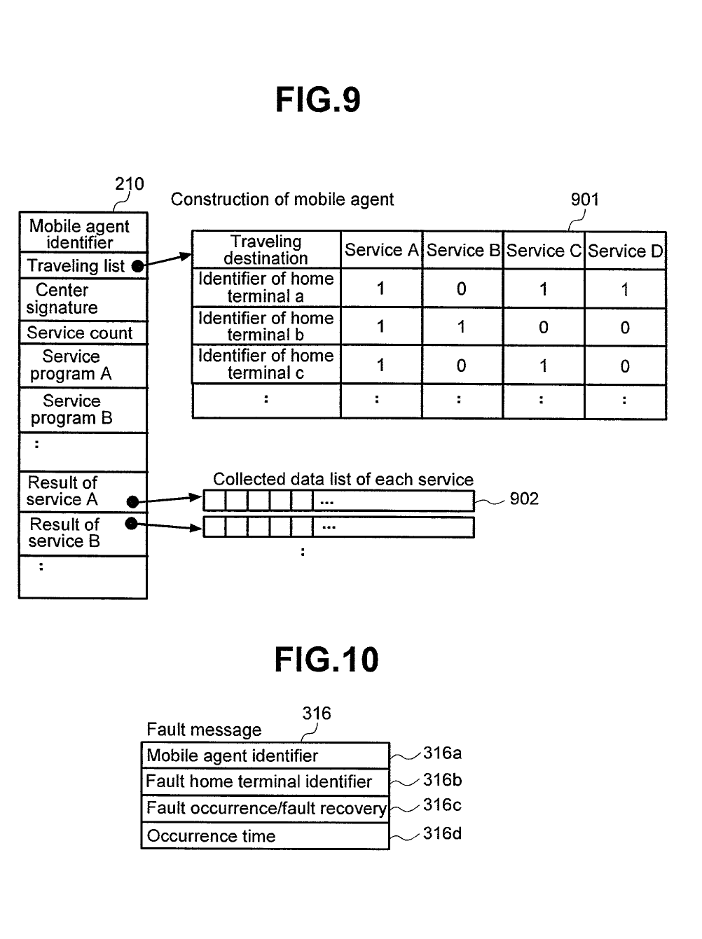

FIG. 9 shows sample contents of the mobile agent 210. The mobile agent 210 is formed from a mobile agent identifier 900, a traveling list 901, a center signature, and, for each service program contained in the mobile agent, the service program main body and a collected data list 902 storing the results of each service program. The traveling list 901 is formed from identifiers for the traveling destination home terminals and flag data indicating which of the service programs contained in the mobile agent 210 are to be executed. In the example shown in FIG. 9, the flag data in the traveling list 901 indicates that service A, service C, and service D are executed at the home terminal a and service A and service B are executed at the home terminal b.

FIG. 10 shows sample contents of the fault message 316. The fault message 316 is formed from a mobile agent identifier 316a, a home terminal identifier 316b of the home terminal experiencing a fault, a fault occurrence/recovery 316c, and an event occurrence time 316d. If, during traveling, a mobile agent cannot be sent to the home terminal at the next traveling destination for some reason, the originating home terminal generates the fault message 316 and sends it to the server 100.

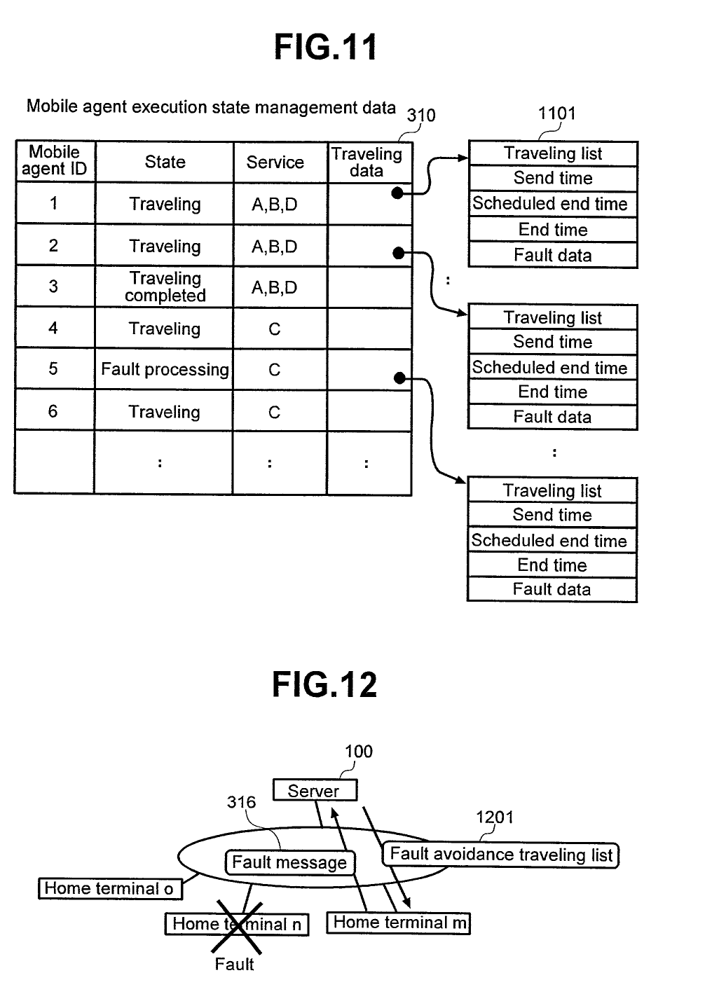

FIG. 11 shows sample contents of the mobile agent execution state management data 310, which is used to manage the execution state of a mobile agent that has been sent out. The agent execution state management data 310 is formed from a mobile agent ID, a mobile agent state (e.g., traveling, traveling completed, fault processing), a list of service program names contained in the mobile agent, and traveling data 1101. The traveling data 1101 is formed from a traveling list, a send time, a scheduled end time, and an end time for the mobile agent, as well as fault data. The mobile agent distributor 106 performs operations to manage the traveling state and fault state of a mobile agent based on the mobile agent execution state management data 310.

In the example shown in FIG. 11, if a mobile agent 2 completes its traveling and returns, the mobile agent terminator 308 updates the status for the mobile agent 2 in the mobile agent execution state management data 310 to ‘traveling completed’ and records the collected data to external storage. Then, the states of other agents (mobile agent 1, mobile agent 3) containing the same services (services A, B, D) are checked. If all agents have completed traveling, the traveling for services A, B, D is assumed to be completed, and the mobile agents 1, 2, 3 are deleted from the mobile agent execution state management data 310.

If a fault message 316 is sent from a home terminal, the message processor 307 uses the mobile agent execution state management data 310 and the mobile agent identifier in the fault message 316 to determine the mobile agent and the traveling list for which the fault is occurring. Using the traveling list, a fault avoidance traveling list, in which the faulty home terminal is removed from the list, is generated and sent to the home terminal that sent the fault message.

FIG. 12 shows a case where a terminal fault takes place while a mobile agent is traveling. The initial traveling list indicates that the agent should travel to home terminal m, home terminal n, and home terminal o, in that order. A fault occurs at the terminal of the home terminal n, and the fault is detected when the home terminal m attempts to sent to the home terminal n. The home terminal m generates a fault message 316 and sends it to the server 100. The identifier of the home terminal n experiencing the fault and the identifier of the mobile agent are contained in the fault message 316. The server 100 receives the fault message 316 and obtains the traveling list using the mobile agent execution state management data 310 and the mobile agent identifier that was reported. Using this traveling list, the server 100 generates a fault avoidance traveling list 1201 containing home terminal m and home terminal o, in that order, but excluding the failed home terminal n. This list is sent to the home terminal m. The home terminal m uses the fault avoidance traveling list 1201 and sends the mobile agent to the next traveling destination, home terminal o.

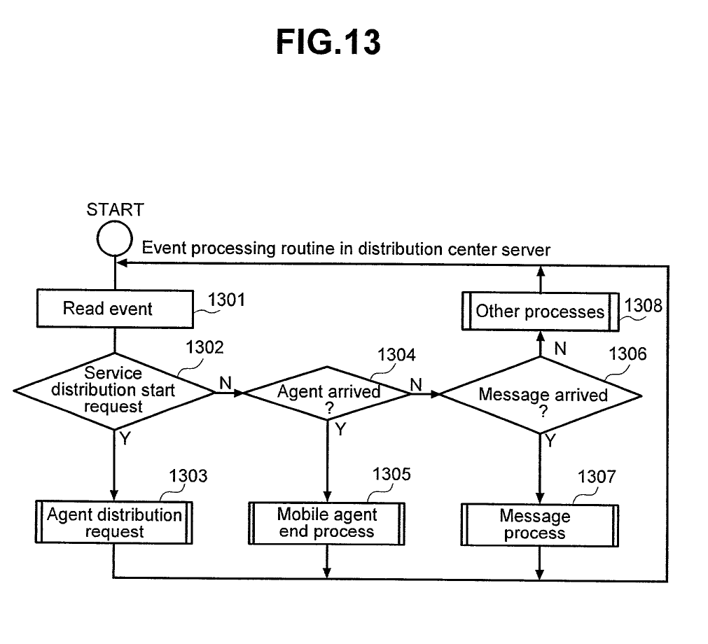

FIG. 13 is a flowchart of event processing operations performed by the server 100 shown in FIG. 1.

Step 1301: An event is read from the event queue.

Step 1302: If the event is a service distribution start request event, control goes to step 1303. Otherwise, control goes to step 1304.

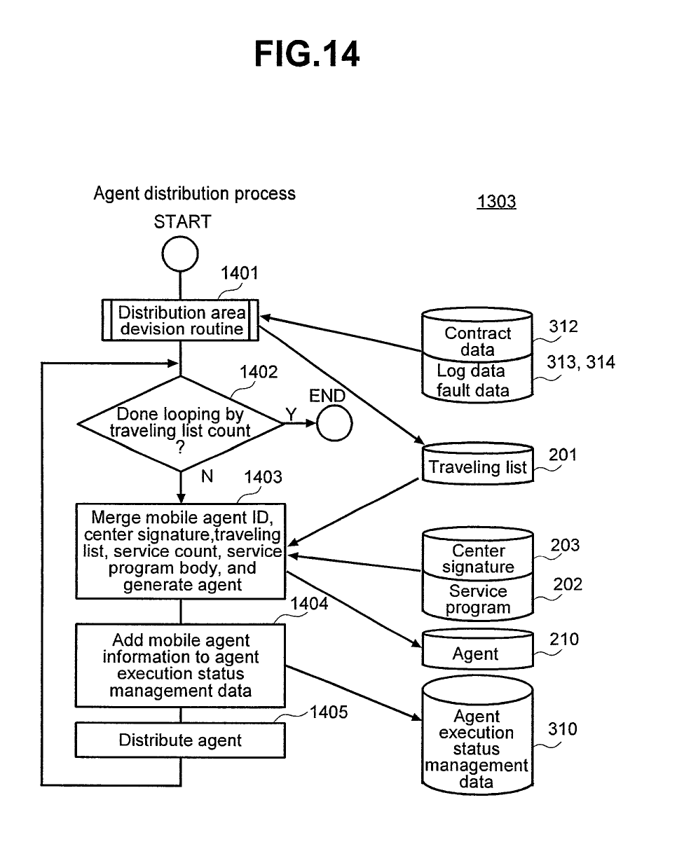

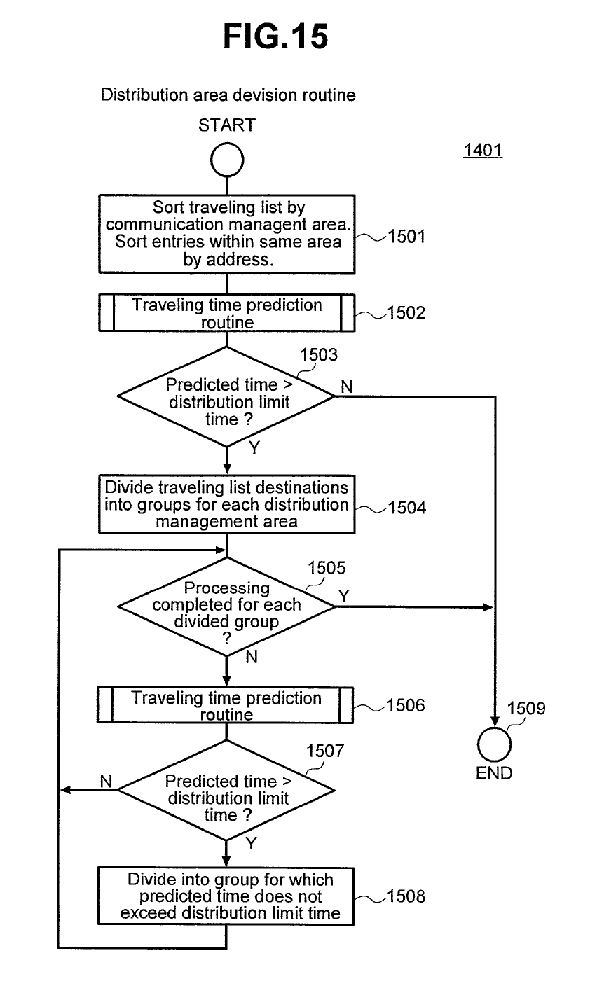

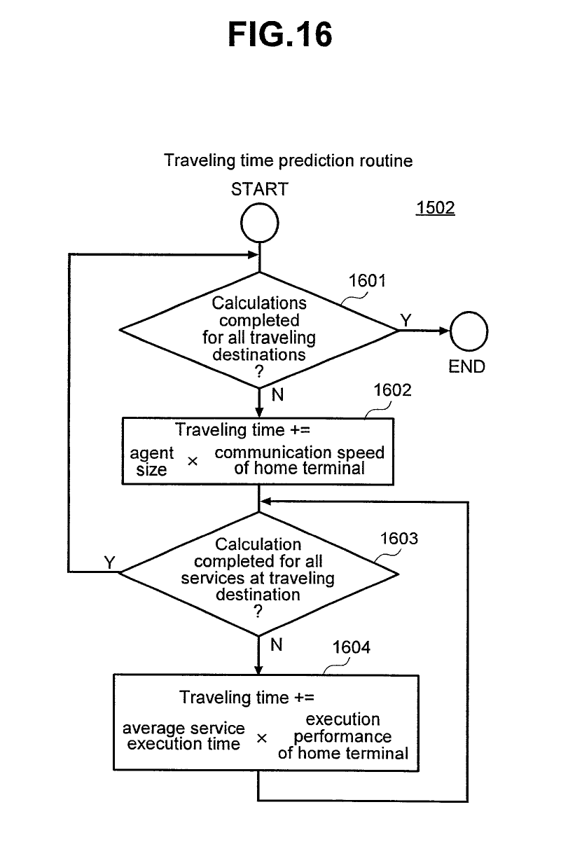

Step 1303: The agent distribution process in the mobile agent distributor 106 is executed and control returns to step 1301. The detailed flow of operations is described in FIG. 14, FIG. 15, and FIG. 16.

Step 1304: If the event is an event arrival notification event, then control goes to step 1305. Otherwise, control goes to step 1306.

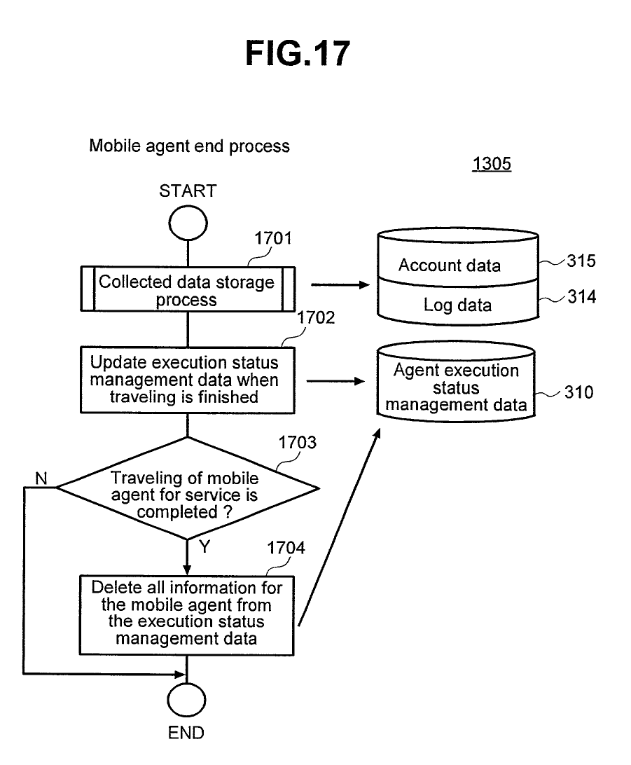

Step 1305: The mobile agent termination process in the mobile agent distributor 106 is executed and control goes back to step 1301. The detailed flow of operations is described in FIG. 17.

Step 1306: If the event is a message arrival notification event, control goes to step 1307. Otherwise, control goes to step 1308.

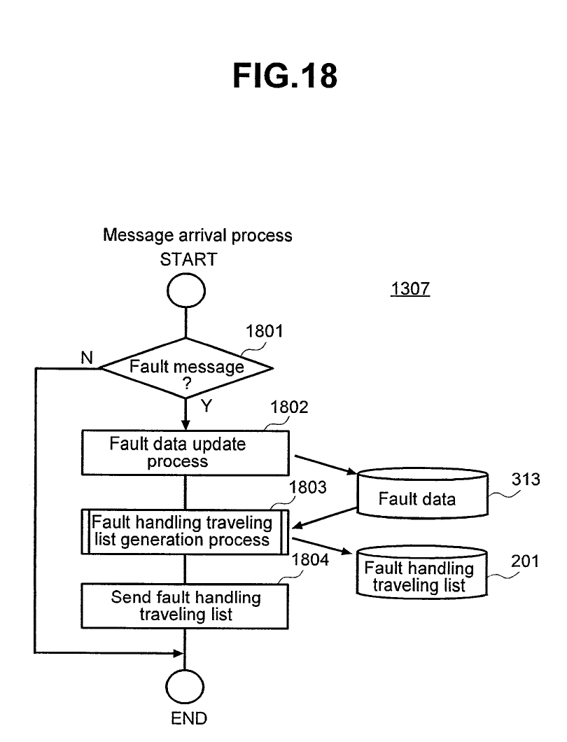

Step 1307: The message process in the mobile agent distributor 106 is executed and control goes to step 1301. The detailed flow of operations is described in FIG. 18.

Step 1308: The server 100 executes other event processing operations that need to be performed, and control goes to step 1301.

FIG. 14 is a flowchart showing the agent distribution process 1303 of the mobile agent distributor which is called by the event processing routing of the server as needed.

Step 1401: The distribution areas for services are divided as necessary, and a traveling list is generated for each area. The detailed flow of operations is described in FIG. 15 and FIG. 16.

Step 1402: A determination is made as to whether step 1403 and step 1404 have been repeated for each traveling list generated at step 1401. If so, the agent distribution process is completed, and control returns to the calling routine.

Step 1403: The mobile agent 210 is generated by joining the traveling list 201, the center signature 203, the number of services contained in the agent, the service program main body 202, and then adding a mobile agent identifier.

Step 1404: Information such as the mobile agent identifier, the traveling list, and the like are added to the agent execution state management data 310.

Step 1404 [?1405?]: The agent generated at step 1403 is sent to the first home terminal entered in the traveling list.

FIG. 15 shows a flowchart of the distribution area division routine 1401 called by the agent distribution routine 1303.

Step 1501: The list of travel destinations is sorted by the communication management area of the home terminal. Entries having the same communication management area are sorted by address.

Step 1502: The predicted traveling time is calculated for the undivided list. The detailed flow of operations for the travel time prediction routine will be described later with reference to FIG. 16.

Step 1503: If the predicted time calculated at step 1502 is greater than the distribution limit time, control goes to step 1504. Otherwise, control goes to step 1509.

Step 1504: The traveling list is divided up by communication management areas of the home terminals.

Step 1505: A determination is made as to whether steps 1506, step 1507, and step 1508 have been executed for all the divided traveling groups. If so, control goes to step 1509. Otherwise, control goes to step 1506 so that the next traveling group can be processed.

Step 1506: The predicted traveling time for the traveling list is calculated. As in step 1502, the details of this operation are shown in FIG. 16.

Step 1507: If the predicted time calculated at step 1506 is greater than the distribution limit time, control goes to step 1508. Otherwise control goes to step 1505.

Step 1508: Predicted times are calculated successively beginning with the start of the traveling list. The traveling list is split at a point right before the home terminal with the predicted time that exceeds the distribution limit time. The former section is set up as one traveling list. This operation is repeated for the remaining part of the traveling list. Thus, divisions are made so that none of the traveling lists will have a predicted time that exceeds the distribution limit time.

FIG. 16 shows a flowchart of the traveling time prediction routine 1502, which calculates a predicted traveling time for a single traveling list.

Step 1601: A loop to calculate the sum of predicted times for all the home terminals in the traveling list. If the calculation is completed, the traveling time prediction routine is completed and control returns to the calling routine. Otherwise, control goes to step 1602. The predicted traveling time is initialized only for the first loop.

Step 1602: The time required to send the mobile agent from the current home terminal to the next home terminal (size of mobile agent*communication speed of the current home terminal) is added to the predicted traveling time, and control goes to step 1603.

Step 1603: A loop to successively calculate predicted execution time for all the services to be executed by the current home terminal. A determination is made as to whether calculation of the predicted execution time has been completed or not. If so, control goes to step 1601. Otherwise, control goes to step 1604.

Step 1604: The time required to execute the current service on the current home terminal (average service execution time*execution performance of the home terminal) is added to the predicted traveling time, and control goes to step 1603.

FIG. 17 is a flowchart for the agent execution exit routine 1305, which is the routine called as needed by the event processing routine of the server and which is performed when the mobile agent has finished its traveling and has returned to the server.

Step 1701: The data collected in the service collected data list 902 of the mobile agent 210 is recorded in the accounting data 315 and the log data 314.

Step 1702: The mobile agent execution state management data 310 is updated so that the state of the current mobile agent is “traveling completed”.

Step 1703: If all mobile agents having the same service as the current mobile agent have completed traveling, control goes to step 1704. Otherwise, the current routine is exited.

Step 1704: The mobile agent information for the current service is deleted from the mobile agent execution state management data 310, and the current routine is exited.

FIG. 18 is a flowchart of the message arrival routine 1307, which is called as necessary by the event processing routine of the server when a message is received due to a fault during traveling.

Step 1801: If the message is a fault message, control goes to step 1702. Otherwise, this routine is exited.

Step 1802: The contents of the fault message are added to the fault data 313.

Step 1803: The traveling list is obtained from the fault message and the mobile agent execution state management data. The faulty home terminal indicated in the fault data is deleted from the list and the fault avoidance traveling list 201 is generated.

Step 1804: The fault avoidance traveling list 201 generated at step 1803 is sent to the home terminal from which the fault message was received. The current routine is exited.

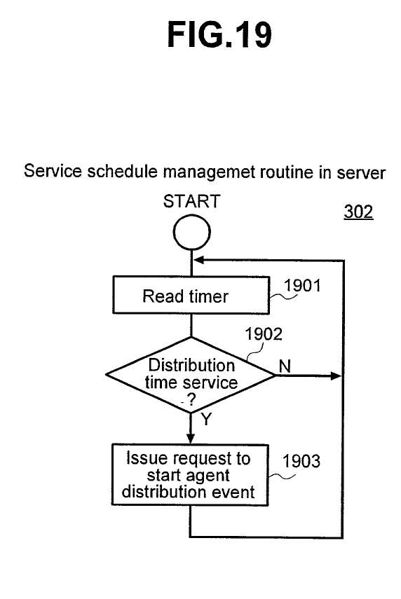

FIG. 19 is a flowchart of the service schedule management routine, which operates independently from the event processing routine of the server and which manages the initiation of mobile agent distribution.

Step 1901: Current time information is obtained from the time.

Step 1902: If there is a service to be distributed at the current time, control goes to step 1903. Otherwise, control goes to step 1901.

Step 1903: A start agent distribution request event is issued.

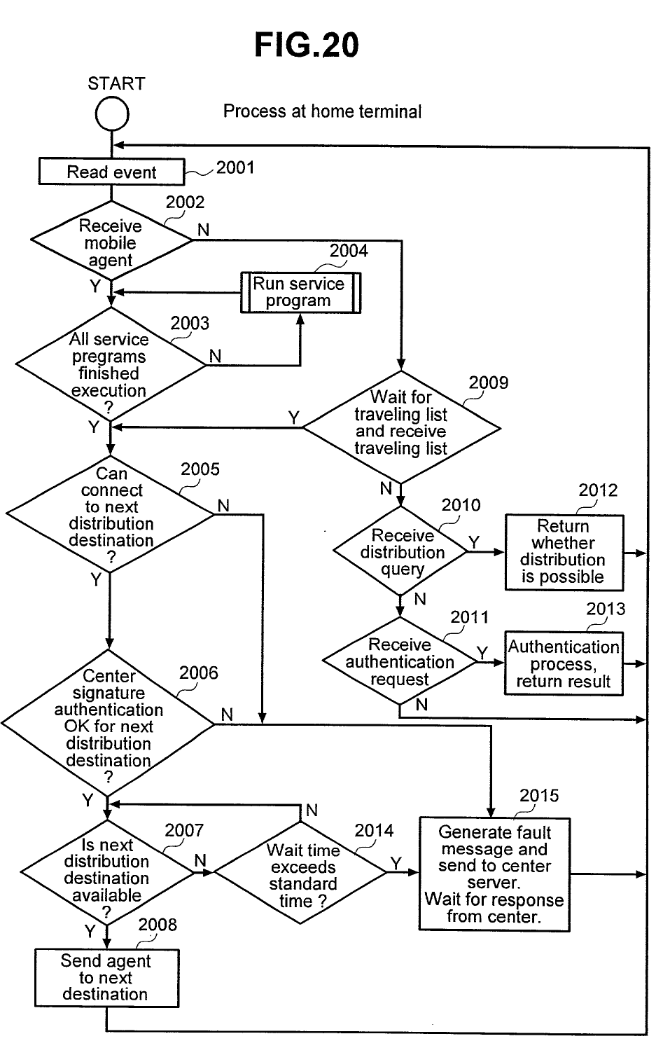

Next, FIG. 20 is a flowchart of an event processing routine in the home terminal, including a mobile agent execution operation.

Step 2001: Read event from event queue.

Step 2002: If a mobile agent is being received, control goes to step 2003. Otherwise, control goes to step 2009.

Step 2003: If all service programs to be executed at the current home terminal have finished execution, control goes to step 2005. Otherwise, control goes to step 2004.

Step 2004: One service program is executed and control returns to step 2003.

Step 2005: Determine if a connection can be established with the next distribution destination. If so, control goes to step 2006. Otherwise, control goes to step 2015.

Step 2006: Determine if the center signature is authenticated by the next distribution destination. If authenticated, control goes to step 2007. Otherwise, control goes to step 2015.

Step 2007: Determine if distribution to the next distribution destination is possible. If so, control goes to step 2008. Otherwise, control goes to step 2014.

Step 2008: Agent is sent to the next distribution destination and control goes to step 2001.

Step 2009: If a traveling list is received while waiting for a traveling list, control goes to step 2005. Otherwise, control goes to step 2010.

Step 2010: If a query regarding whether distribution is possible is received, control goes to step 2012. Otherwise, control goes to step 2011.

Step 2011: If a center signature authentication request is received, control goes to step 2013. Otherwise, control goes to step 2001.

Step 2012: An indication of whether or not distribution is possible is returned, and control goes to step 2001.

Step 2013: A center signature authentication process is executed and the result is sent back. Control goes to step 2001.

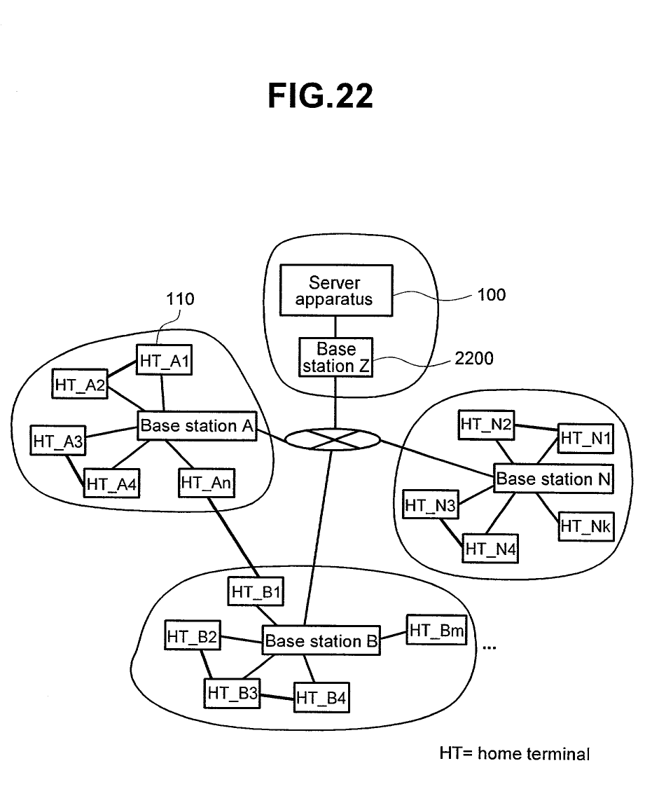

Next, another embodiment using the present invention will be described, with references to FIG. 1 through FIG. 3, FIG. 6 through FIG. 14, FIG. 16 through FIG. 19, and FIG. 22 through FIG. 29.

As in the embodiment described above, the server apparatus 100 and the home terminal 110 have the hardware architectures shown in FIG. 1. However, mobile telephones are used for the communication devices 104, 114, and communication takes place through base stations 2200, as shown in FIG. 22. But as shown home terminal A1 and home terminal A2 in FIG. 22, if a home terminal is able to connect in transceiver mode, it directly communicates in transceiver mode. Connecting in transceiver mode is saving the communication cost.

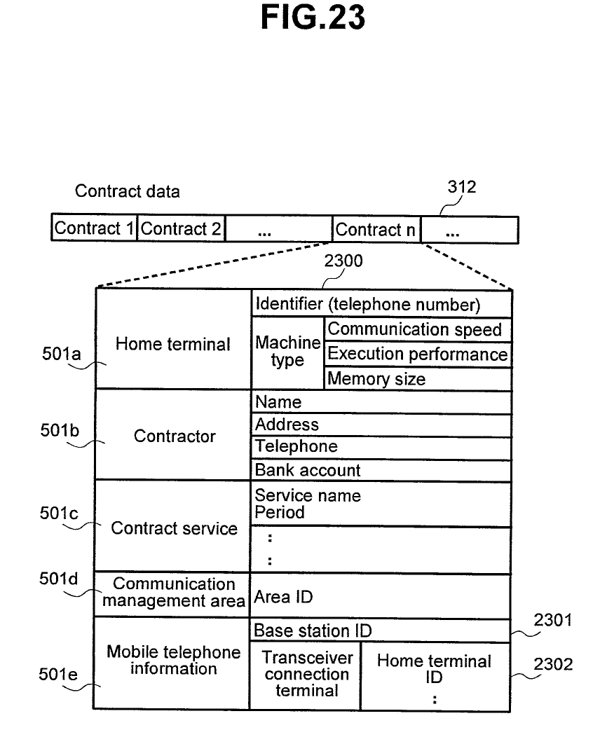

As shown in FIG. 23, contract data is represented using contract data 2300, where mobile telephone information 501e is added to the contract data 501 from the embodiment described above. The mobile telephone information 501e is formed from home terminal connection base station information 2301 and home terminal information 2302 about home terminals that can establish connections in transceiver mode.

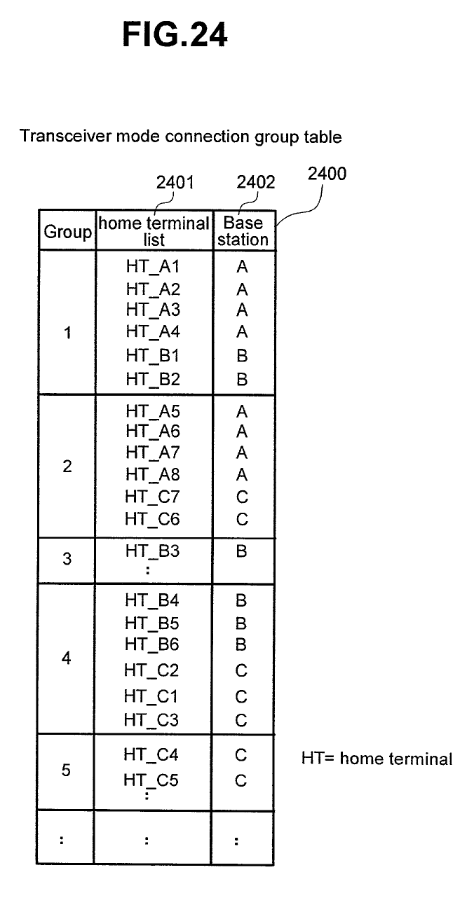

When sending out a mobile agent, the server 100 first uses the contract data 2300, the fault data 313, the log data 314, and the service program 202 data to form, out of the home terminals that will be traveled, groups of home terminals capable of connecting in transceiver mode. A transceiver mode connection group table 2400, as shown in FIG. 24, is generated. The transceiver mode connection group table 2400 is formed from a list 2401 of home terminals capable of communicating in transceiver mode, and base station ID 2401. A traveling list is created using these groups as the smallest unit. The traveling list is created so that the home terminals in a single traveling list connect to at least two base stations. Home terminals that cannot connect to any home terminals in transceiver mode are sorted by communication management area and address as in the embodiment described above and then put in a group to form a traveling list.

If, when the mobile agent is traveling and is being returned to the server from a home terminal by way of a connecting base station, a fault occurs in the connecting base station, the home terminal successively issues a search request for a working base station to all the home terminals that the current home terminal can reach in transceiver mode.

A home terminal receives the search request and returns its own terminal ID if the base station to which it connects is working. If its own base station is also not working, it sends search requests to other terminals to which it can connect in transceiver mode, thus continuing the search. The search is continued until a working base station is found or until there are no more home terminals that can be connected to in transceiver mode. If the search responses in a working base station being found, the mobile agent is successively sent in transceiver mode to the home terminal with the returned terminal ID. Communication is then performed from the terminal that was the result of the search by way of its base station.

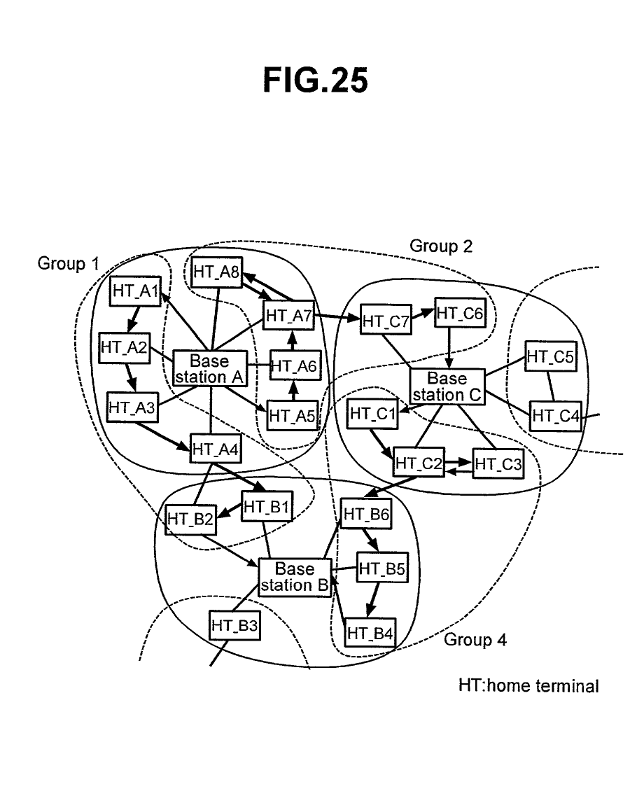

FIG. 25 shows an example of traveling lists for a mobile agent. A fault avoidance method for cases when a fault occurs at a base station will be described in detail. Group 1 is one traveling list where traveling starts at home terminal A1 and follows the sequence of arrows in the figure. Adjacent home terminals in the traveling list are able to communicate in transceiver mode. The traveling of the mobile agent ends at home terminal B2 and the agent is to be returned to the server by way of a base station B when the home terminal B2 discovers that a fault has occurred at the base station B. At this point, the home terminal B2 issues a base station search request to the home terminal B1. Since the base station B to which the home terminal B1 connects is not working, the home terminal B1 sends a base station search request to a home terminal A4. The home terminal A4 receives the base station search request and confirms that its own base station A is operating normally. It then sends its own home terminal ID back to the home terminal B1. The home terminal B1 sends this response to the home terminal B2. The home terminal B2 receives the search response and sends the mobile agent to the home terminal A4 using transceiver mode communication. Then, the mobile agent is returned to the server from the home terminal A4 by way of the base station A.

By creating lists so that each list contains at least two base stations to which home terminals connect, fault avoidance is possible when there is a fault at one base station. In such cases, the mobile agent is moved using transceiver mode communication to a home terminal that connects to a working base station. From there, the mobile agent is sent to the server or a home terminal with a different base station.

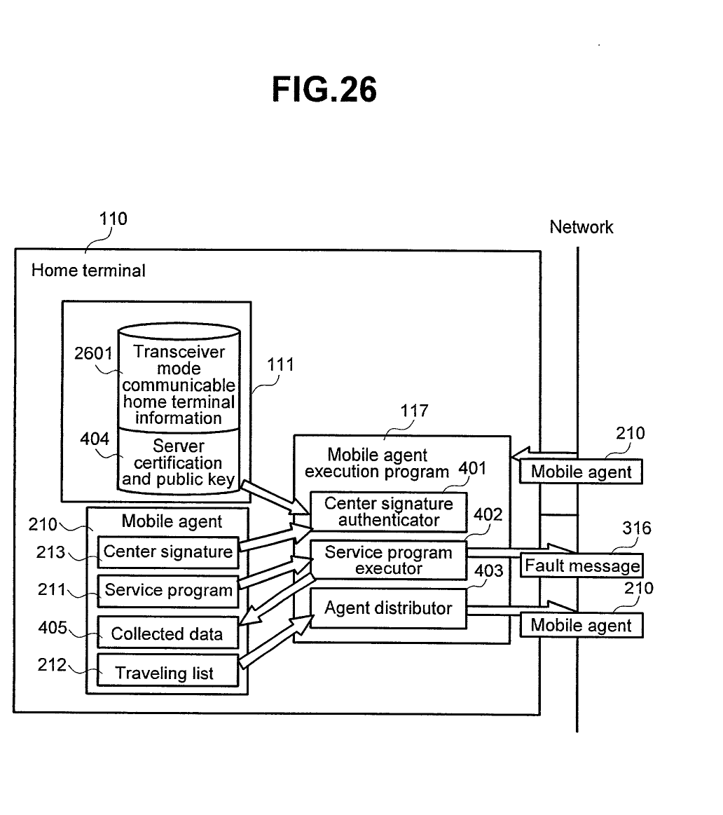

As shown in FIG. 26, the home terminal 101 in the system that implements this embodiment stores information 2601 about home terminals that can communicate in transceiver mode. Otherwise, the architecture is identical to that shown in FIG. 4.

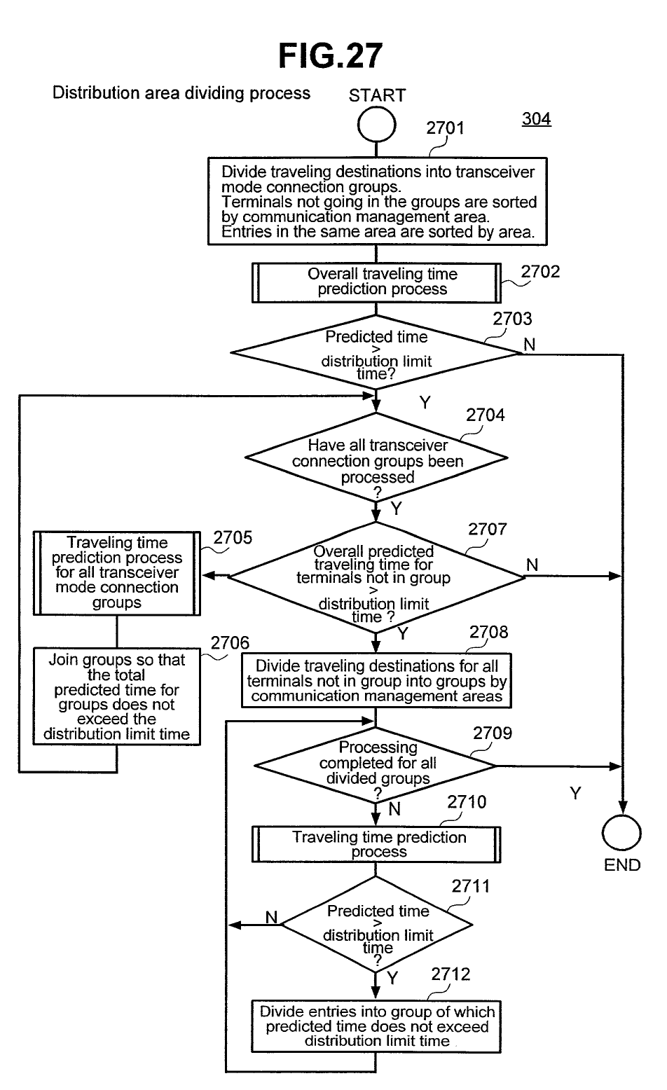

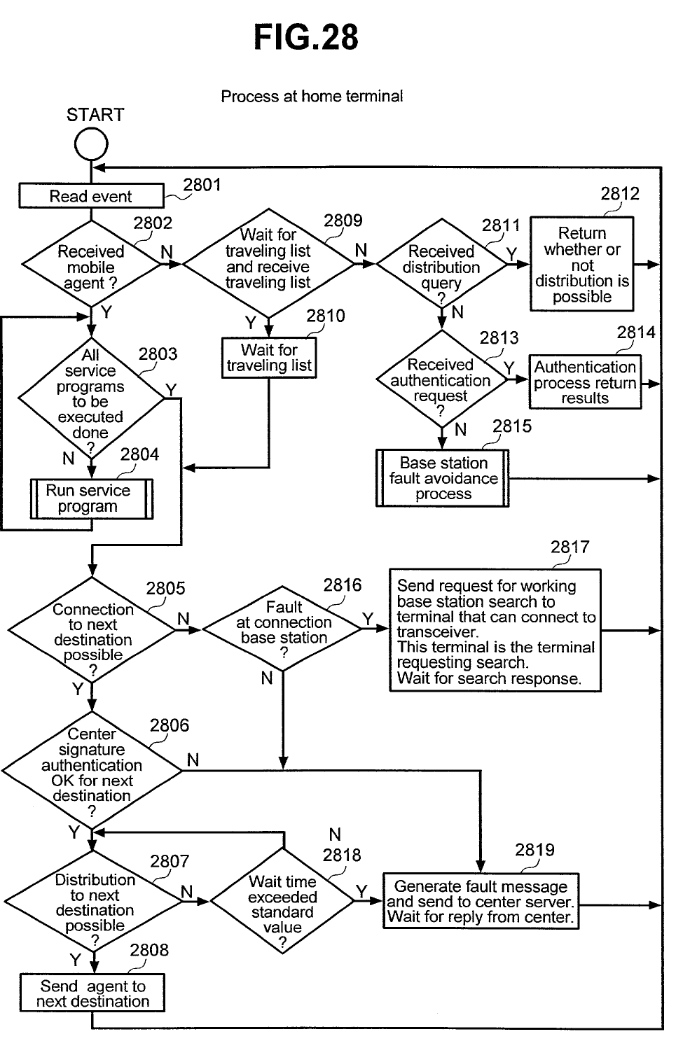

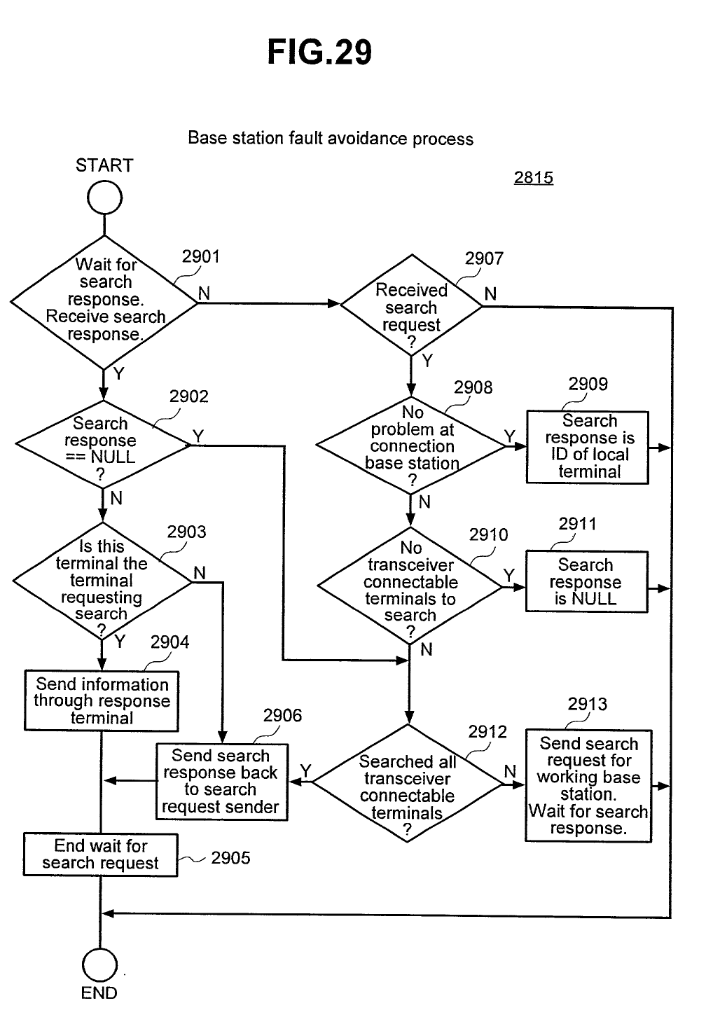

To implement this embodiment, changes must be made to the operations performed by the distribution area divider 304 of the mobile agent distributor 106 and the mobile agent executor 117 in the home terminals. FIG. 27 is a flowchart showing the flow of operations performed by the distribution area divider 304. FIG. 28 and FIG. 29 are flowcharts showing the flow of operations performed by the mobile agent executor 117. FIG. 27 is a modified version of FIG. 15 and FIG. 28 is a modified version of FIG. 20.

Step 2701: The traveling destination home terminals are divided into transceiver mode connection groups. The home terminals that cannot be placed in these groups are sorted by communication area, with entries in the same area being sorted by address.

Step 2702: The predicted time for the entire traveling operation is calculated with the traveling time prediction routine. The detailed flow of operations of the traveling time prediction routine is described above with reference to FIG. 16.

Step 2703: If the predicted time calculated at step 2702 is greater than a defined distribution limit time, control goes to step 2704. Otherwise, the routine is exited. Step 2704: Step 2705 and step 2706 are performed for each of the transceiver mode connection groups. When done, control goes to step 2707.

Step 2705: The predicted traveling time for a single group is calculated using the traveling time prediction routine.

Step 2706: Groups are formed so that the total predicted times of groups do not exceed the defined distribution limit time.

Step 2707: If the predicted time for traveling all home terminals not included in a group exceeds a defined distribution limit time, control goes to step 2708. Otherwise, the routine is exited.

Step 2708: The home terminals not included in a group are divided into groups based on communication management areas.

Step 2709: Step 2710, step 2711, and step 2712 are performed for the groups formed at step 2708. Once all groups have been processed, the routine is exited.

Step 2710: The predicted traveling time for a single group is calculated. Details of this operation are indicated in FIG. 16.

Step 2711: If the predicted traveling time calculated at step 2710 is greater than the defined distribution limit time, control goes to step 2712. Otherwise, control goes to step 2709.

Step 2712: Groups are formed so that the predicted traveling time does not exceed the defined distribution limit time.

FIG. 28 shows the operations performed by the mobile agent execution program 117 in the home terminals, including the base station fault avoidance operations.

Step 2801: Read event from event queue.

Step 2802: If the event is arrival of a mobile agent, control goes to step 2803. Otherwise, control goes to step 2809.

Step 2803: Repeat step 2804 until all service programs to be executed are completed. After completion, control goes to step 2805.

Step 2804: Execute service program.

Step 2805: Determine if connection to the next distribution destination is possible or not. If possible, control goes to step 2806. If not, control goes to step 2816.

Step 2806: Perform center signature authentication for the next distribution destination. If authenticated, control goes to step 2807. Otherwise, control goes to step 2819.

Step 2807: Query whether or not distribution is possible to the next distribution destination. If so, control proceeds to step 2808. Otherwise, control proceeds to step 2818.

Step 2808: Send mobile agent to next distribution destination.

Step 2809: If waiting for traveling list from the center server and event is arrival of traveling list, control goes to step 2810. Otherwise, control goes to step 2811.

Step 2810: End traveling list wait state and go to step 2805.

Step 2811: If event is arrival of query for status of whether distribution is possible, control goes to step 2812. Otherwise, control goes to step 2813.

Step 2812: Return whether or not distribution is possible.

Step 2813: If event is arrival of authentication request, control goes to step 2814. Otherwise, control goes to step 2815.

Step 2814: Perform authentication of center signature and return result.

Step 2815: Perform base station fault avoidance operations. The flow of operations in the base station fault avoidance operations is shown in FIG. 29 and will be described later.

Step 2816: If there is a fault at the connection base station, control goes to step 2817. Otherwise, control goes to step 2819.

Step 2817: Search request for working base station is sent from current home terminal to a terminal that can be reached by transceiver mode communication. The current terminal is set to be the terminal from which the search request originated. The current terminal is set to wait for a search response.

Step 2818: When waiting for distribution to the next distribution destination to be possible, if the wait time exceeds the standard value control proceeds to step 2819. Otherwise, control goes to step 2807.

Step 2819: A fault message is generated and sent to the center server. The terminal waits for a reply (fault avoidance traveling list) from the center.

FIG. 29 shows the flow of operations in the base station fault avoidance routine 2815 called from the mobile agent execution program 117 as described above.

Step 2901: If waiting for a base station search response and the event is a search response arrival event, control goes to step 2902. Otherwise, control goes to step 2907.

Step 2902: If the search response is NULL, control goes to step 2912. Otherwise, control goes to step 2903.

Step 2903: If the current home terminal is the search request originating terminal, control goes to step 2904. Otherwise, control goes to step 2906.

Step 2904: The agent and a fault notification is sent to the center by way of the home terminal in the search response.

Step 2905: End base station search response wait state.

Step 2906: Send search response to search request originator.

Step 2907: If the event is the arrival of a base station search request, control goes to step 2908. Otherwise, the routine is exited.

Step 2908: If there is no problem at the connection base station of the current home terminal, control goes to step 2909. Otherwise, control goes to step 2910.

Step 2909: The current home terminal ID is sent back as the search response and the routine is exited.

Step 2910: If there are no unsearched terminals that can be connected to in transceiver mode, control goes to step 2911. Otherwise, control goes to step 2912.

Step 2911: Return NULL as the search response and exit routine.

Step 2912: If searching has been performed for all terminals to which the current home terminal can connect in transceiver mode, control goes to step 2906. Otherwise, control goes to step 2913.

Step 2913: Issue working base station search request to unsearched terminal that can be connected in transceiver mode. Enter base station search response wait state and exit routine.

With the present invention as described above, traveling lists are managed separately from agent programs and traveling time is predicted based on home terminal information at traveling destinations and information about programs to be executed at traveling destinations. The traveling destinations are divided into multiple groups as needed and agent distribution is performed through these groups. This allows the time involved in traveling to be controlled.

What is claimed is:

1. In a network system connecting a server and at least one node serving as a home terminal, a method for controlling a mobile agent comprising the following steps:
storing in said server traveling data indicating which nodes to travel;
sending from said server to said node a mobile agent containing said traveling data and distribution data formed from a program to be executed at said node and/or data to be used by said node;
loading and executing said program at said node to which said mobile agent is sent;
determining a node to be moved to next by reading said traveling data attached to said mobile agent; and
sending said mobile agent to a node determined by said node.

2. A method for controlling a mobile agent as described in claim 1 wherein said nodes to be traveled by said mobile agent are divided into a plurality of groups, and said distribution data is distributed to each of said plurality of groups.

3. A method for controlling a mobile agent as described in claim 2 wherein said groups are divided so that a group traveling time of each group is no greater than a predetermined time, where said group traveling time is a sum of times required to travel a single node.

4. A method for controlling a mobile agent as described in claim 2 wherein said groups are divided to form a predetermined number of groups by selecting nodes so that said group traveling times for said groups are uniform.

5. A method for controlling a mobile agent as described in claim 2 wherein said groups are divided to reduce communication costs between nodes.

6. A method for controlling a mobile agent as described in claim 2 wherein: two sets of said distribution data having identical contents except for said traveling data are sent to a group; traveling data of one distribution data is in an opposite sequence from traveling data of another distribution data; and traveling is completed when said two sets of said distribution data meet.

7. A method for controlling a mobile agent as described in claim 1 wherein when a fault in a node is discovered, fault information is stored in said server and said fault information is displayed to said display device.

8. A method for controlling a mobile agent as described in claim 7 wherein traveling data excluding said fault information stored in said server is added to said mobile agent.

9. A method for controlling a mobile agent as described in claim 1 wherein distribution is performed according to a schedule created beforehand.

10. A method for controlling a mobile agent as described in claim 1 wherein said traveling data is maintained and managed by editing said traveling data.

11. A method for controlling a mobile agent as described in claim 1 wherein: said node includes means for communicating by way of a base station as in mobile telephones and means for making transceiver connections to communicate with other nodes without going through said base stations; said plurality of nodes is divided into groups of nodes that can make transceiver connections with each other; when said transceiver connectable nodes communicate by way of transceiver connections and other nodes connect by way of said base stations, groups are divided so that each group contains at least two of said base stations.

12. A method for controlling a mobile agent as described in claim 11 wherein when a fault occurs at a base station capable of being connected to a node and communication to said server or nodes in other groups is not possible, an agent is sent by way of a transceiver connection to a node capable of connecting with a working base station, and said agent is sent from said connectable node to said server or another group.

13. A method for controlling a mobile agent as described in claim 12 wherein when a fault occurs at a base station, transceiver-connectable nodes are searched to find a node that can connect to a working base station.

14. In a server connected to at least one node serving as a traveling destination and executing a mobile agent, a method for controlling a mobile agent comprising the following steps:
predicting beforehand a reveling time needed for traveling based on traveling destination information and distribution data information;
dividing traveling destinations into a plurality of groups so that said traveling time is no greater than a predetermined value; and
distributing mobile agents to each of said groups.

15. A computer-readable recording medium holding a program for a method for controlling a mobile agent executed by a server connected to at least one node serving as a traveling destination and executing a mobile agent, said method comprising the following steps:
predicting beforehand a traveling time needed for traveling based on traveling destination information and distribution data information;
dividing traveling destinations into a plurality of groups so that said traveling time is no greater than a predetermined value; and
distributing mobile agents to each of said groups.

16. A mobile agent controlling apparatus connected to at least one node serving as a traveling destination and executing a mobile agent comprising:
means for predicting beforehand a traveling time needed for traveling based on traveling destination information and distribution data information;
means for dividing traveling destinations into a plurality of groups so that said traveling time is no greater than a predetermined value; and
means for distributing mobile agents to each of said groups.
